(19) United States
(12) Patent Application Publication
(10) Pub. No.: US 2026/0208044 A1
(43) Pub. Date: Jul. 23, 2026

(54) COLLABORATIVE AUTHORING OF A SITE-SPECIFIC AUGMENTED REALITY EXPERIENCE

(71) Applicant: Niantic Spatial, Inc., San Francisco, CA (US)

(72) Inventors: Nels Numan, Seattle, WA (US); Gabriel J. Brostow, Bristol (GB); Jessica Van Brummelen, London (GB)

(21) Appl. No.: 19/451,480

(22) Filed: Jan. 16, 2026

Related U.S. Application Data
(60) Provisional application No. 63/746,485, filed on Jan. 17, 2025.

(51) Int. Cl. A63F 13/52; A63F 13/2145; G06F 3/04815; G06F 3/0482; G06F 3/04883; G06T 19/00; G06F 3/16

(52) U.S. Cl. CPC A63F 13/52; A63F 13/2145; G06F 3/04815; G06F 3/0482; G06F 3/04883; G06T 19/006; G06F 3/167; G06T 2200/24; G06T 2219/004; G06T 2219/024

(57) ABSTRACT

An on-site client device and an off-site client device coordinate to author a site-specific Augmented reality (AR) experience. The on-site client device is located at or near the site and displays an initial version of the AR experience. The on-site provides a user interface including a menu that enables an on-site user to provide annotations on the AR experience. The annotations are provided to the off-site client device. As off-site user can view the annotations at the off-site client device and use them to update the AR experience.

### CROSS-REFERENCE TO RELATED APPLICATIONS

The present application claims the benefit of and priority to U.S. Provisional Application No. 63/746,485 filed on January 17, 2025, which is incorporated by reference.

### BACKGROUND

1. Technical Field

The subject matter described relates generally to augmented reality (AR) experience generation.

### 2. Problem

Developers of site-specific outdoor augmented reality (AR) experiences need a detailed understanding of real world conditions to create immersive and relevant content. Oftentimes spatial information must be gleaned from static 3D models. However, these representations are often inadequate. They may have gaps, may be outdated, or may fail to capture safety considerations, user flow, and environmental changes. On-site visits can aid in gathering additional information to fill in these inadequacies, but this disjointed workflow can create added friction and delay in the authoring process.

### SUMMARY

The present disclosure describes a workflow for collaborative authoring of a site-specific AR experience. The workflow includes an ex-situ developer located remotely off-site and an in-situ user located on-site. The ex-situ developer initializes an AR experience for a real-world site. The AR experience is transmitted for presentation on the in-situ user’s client device. The in-situ user’s client device includes a camera assembly for capturing image data of the real-world site, which may then be used to localize the client device in the real-world site. Based on the localization data, the client device may render the AR experience in conjunction with the image data captured by the camera assembly. The in-situ user’s client device may further generate spatial models (e.g., point clouds, or meshes) of the real-world site. As the in-situ user is on-site rendering the AR experience, the in-situ user’s client device provides an interface for the in-situ user to create commentary to the AR experience. The commentary may include handwritten notes, drawings, audio recordings, labels indicating state of different objects in the site, other forms of input, etc. The in-situ user’s client devices transmits the commentary to the ex-situ developer’s client device. The ex-situ developer’s client device may display a spatial model of the real-world site, which may be refined by spatial models captured by the in-situ user’s client device and/or appended with commentary from the in-situ user.

### BRIEF DESCRIPTION OF THE DRAWINGS

FIG. 1 illustrates a networked computing environment, according to one embodiment.

FIG. 2 depicts a representation of a virtual world having a geography that parallels the real world, according to one embodiment.

FIG. 3 depicts an exemplary game interface of a parallel reality game, according to one embodiment.

FIG. 4 illustrates a networked computing environment for collaborative authoring of an AR experience, according to one embodiment.

FIG. 5 illustrates an example user interface for an in-situ user’s client device, according to one embodiment.

FIG. 6 illustrates an example user interface for an ex-situ developer’s client device, according to one embodiment.

FIG. 7 illustrates a method flowchart describing a process of in-situ collaboration in AR authoring, according to one embodiment.

FIG. 8 illustrates a method flowchart describing a process of ex-situ collaboration in AR authoring, according to one embodiment.

FIG. 9 illustrates an example computer system suitable for use in training or applying a depth estimation model, according to one embodiment.

The figures and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures.

### DETAILED DESCRIPTION

### Exemplary Location-Based Parallel Reality Gaming System

Various embodiments are described in the context of a parallel reality game that includes augmented reality content in a virtual world geography that parallels at least a portion of the real-world geography such that player movement and actions in the real-world affect actions in the virtual world and vice versa. Those of ordinary skill in the art, using the disclosures provided herein, will understand that the subject matter described is applicable in other situations where determining depth information from image data is desirable. In addition, the inherent flexibility of computer-based systems allows for a great variety of possible configurations, combinations, and divisions of tasks and functionality between and among the components of the system. For instance, the systems and methods according to aspects of the present disclosure can be implemented using a single computing device or across multiple computing devices (e.g., connected in a computer network).

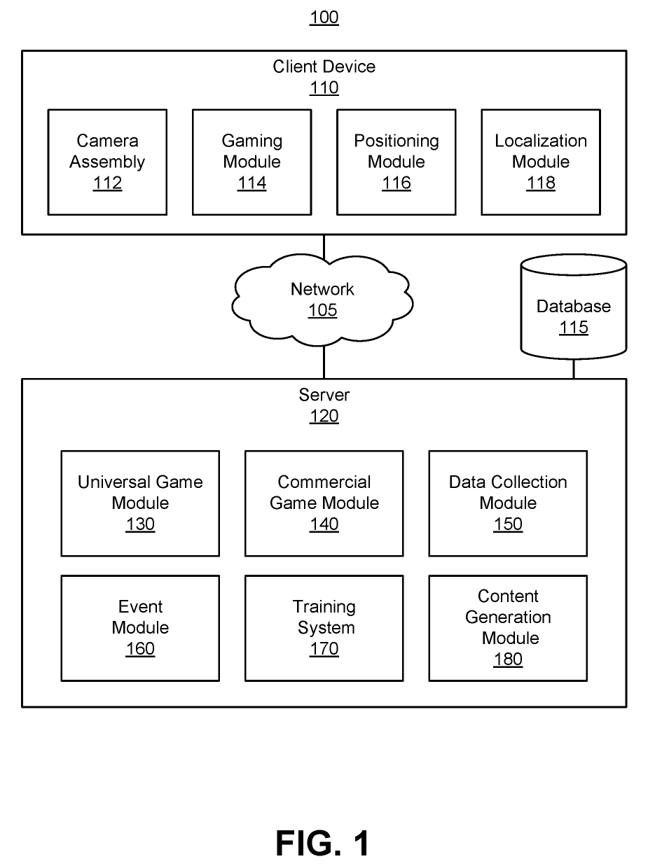

FIG. 1 illustrates a networked computing environment 100, according to one or more embodiments. The networked computing environment 100 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player’s position in the real world can be tracked and used to update the player’s position in the virtual world. Typically, the player’s position in the real world is determined by finding the location of a client device 110 through which the player is interacting with the virtual world and assuming the player is at the same (or approximately the same) location. For example, in various embodiments, the player may interact with a virtual element if the player’s location in the real world is within a threshold distance (e.g., ten meters, twenty meters, etc.) of the real-world location that corresponds to the virtual location of the virtual element in the virtual world. For convenience, various embodiments are described with reference to “the player’s location” but one of skill in the art will appreciate that such references may refer to the location of the player’s client device 110.

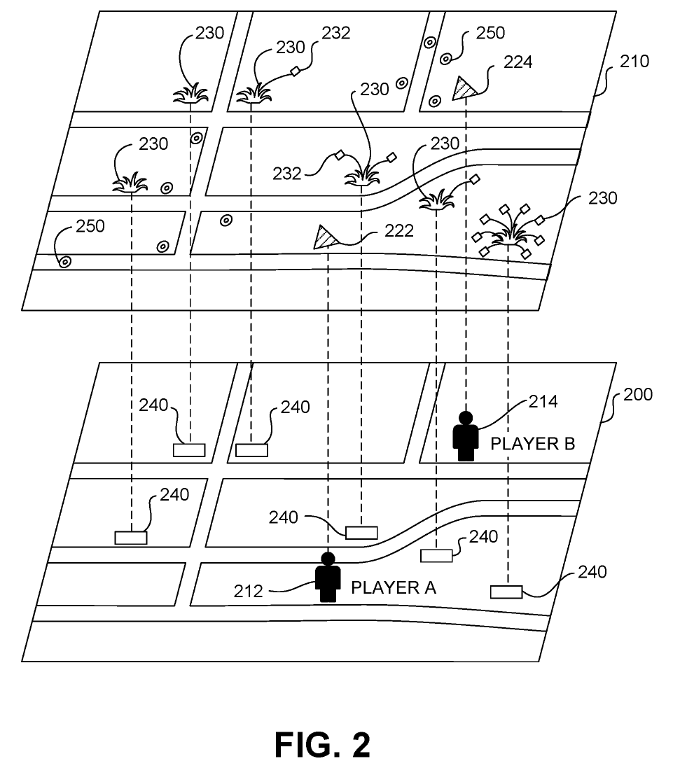

Reference is now made to FIG. 2 which depicts a conceptual diagram of a virtual world 210 that parallels the real world 200 that can act as the game board for players of a parallel reality game, according to one embodiment. As illustrated, the virtual world 210 can include a geography that parallels the geography of the real world 200. In particular, a range of coordinates defining a geographic area or space in the real world 200 is mapped to a corresponding range of coordinates defining a virtual space in the virtual world 210. The range of coordinates in the real world 200 can be associated with a town, neighborhood, city, campus, locale, a country, continent, the entire globe, or other geographic area. Each geographic coordinate in the range of geographic coordinates is mapped to a corresponding coordinate in a virtual space in the virtual world.

A player’s position in the virtual world 210 corresponds to the player’s position in the real world 200. For instance, the player A located at position 212 in the real world 200 has a corresponding position 222 in the virtual world 210. Similarly, the player B located at position 214 in the real world has a corresponding position 224 in the virtual world. As the players move about in a range of geographic coordinates in the real world, the players also move about in the range of coordinates defining the virtual space in the virtual world 210. In particular, a positioning system (e.g., a GPS system) associated with a mobile computing device carried by the player can be used to track a player’s position as the player navigates the range of geographic coordinates in the real world. Data associated with the player’s position in the real world 200 is used to update the player’s position in the corresponding range of coordinates defining the virtual space in the virtual world 210. In this manner, players can navigate along a continuous track in the range of coordinates defining the virtual space in the virtual world 210 by simply traveling among the corresponding range of geographic coordinates in the real world 200 without having to check in or periodically update location information at specific discrete locations in the real world 200.

The location-based game can include a plurality of game objectives requiring players to travel to and/or interact with various virtual elements and/or virtual objects scattered at various virtual locations in the virtual world. A player can travel to these virtual locations by traveling to the corresponding location of the virtual elements or objects in the real world. For instance, a positioning system can continuously track the position of the player such that as the player continuously navigates the real world, the player also continuously navigates the parallel virtual world. The player can then interact with various virtual elements and/or objects at the specific location to achieve or perform one or more game objectives.

For example, a game objective has players interacting with virtual elements 230 located at various virtual locations in the virtual world 210. These virtual elements 230 can be linked to landmarks, geographic locations, or objects 240 in the real world 200. The real-world landmarks or objects 240 can be works of art, monuments, buildings, businesses, libraries, museums, or other suitable real-world landmarks or objects. Interactions include capturing, claiming ownership of, using some virtual item, spending some virtual currency, etc. To capture these virtual elements 230, a player must travel to the landmark or geographic location 240 linked to the virtual elements 230 in the real world and must perform any necessary interactions with the virtual elements 230 in the virtual world 210. For example, player A of FIG. 2 may have to travel to a landmark 240 in the real world 200 in order to interact with or capture a virtual element 230 linked with that particular landmark 240. The interaction with the virtual element 230 can require action in the real world, such as taking a photograph and/or verifying, obtaining, or capturing other information about the landmark or object 240 associated with the virtual element 230.

Game objectives may require that players use one or more virtual items that are collected by the players in the location-based game. For instance, the players may travel the virtual world 210 seeking virtual items (e.g., weapons, creatures, power ups, or other items) that can be useful for completing game objectives. These virtual items can be found or collected by traveling to different locations in the real world 200 or by completing various actions in either the virtual world 210 or the real world 200. In the example shown in FIG. 2, a player uses virtual items 232 to capture one or more virtual elements 230. In particular, a player can deploy virtual items 232 at locations in the virtual world 210 proximate or within the virtual elements 230. Deploying one or more virtual items 232 in this manner can result in the capture of the virtual element 230 for the particular player or for the team/faction of the particular player.

In one particular implementation, a player may have to gather virtual energy as part of the parallel reality game. As depicted in FIG. 2, virtual energy 250 can be scattered at different locations in the virtual world 210. A player can collect the virtual energy 250 by traveling to the corresponding location of the virtual energy 250 in the actual world 200. The virtual energy 250 can be used to power virtual items and/or to perform various game objectives in the game. A player that loses all virtual energy 250 can be disconnected from the game.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. In some embodiments, players can communicate with one another through one or more communication interfaces provided in the game. Players can also obtain enhanced “powers” or virtual items that can be used to complete game objectives within the game. Those of ordinary skill in the art, using the disclosures provided herein, should understand that various other game features can be included with the parallel reality game without deviating from the scope of the present disclosure.

Referring back FIG. 1, the networked computing environment 100 uses a client-server architecture, where a server 120 communicates with a client device 110 over a network 105, e.g., to provide a parallel reality game to players at the client device 110. The networked computing environment 100 may provide other computer functionality, e.g., generating virtual content in part by the server 120 for distribution to the client device 110, or generating navigational instructions by the server 120 for controlling operation of a client device 110 embodied as an autonomous agent. The networked computing environment 100 also may include other external systems such as other content creation systems or business systems. Although only one client device 110 is illustrated in FIG. 1, any number of clients 110 or other external systems may be connected to the server 120 over the network 105. Furthermore, the networked computing environment 100 may contain different or additional elements and functionality may be distributed between the client device 110 and the server 120 in a different manner than described below.

A client device 110 can be any portable computing device that can be used by a player to interface with the server 120. For instance, a client device 110 can be a wireless device, a personal digital assistant (PDA), portable gaming device, cellular phone, smart phone, tablet, navigation system, handheld GPS system, wearable computing device, a display having one or more processors, or other such device. In another instance, the client device 110 includes a conventional computer system, such as a desktop or a laptop computer. Still yet, the client device 110 may be a vehicle with a computing device. In short, a client device 110 can be any computer device or system that can enable a player to interact with the server 120. As a computing device, the client device 110 can include one or more processors and one or more computer-readable storage media. The computer-readable storage media can store instructions which cause the processor to perform operations. The client device 110 is preferably a portable computing device that can be easily carried or otherwise transported with a player, such as a smartphone or tablet.

In an embodiment, the client device executes an application allowing the user of the client device 110 to interact with the server 120 or other components of the system environment 100. For example, a client device 110 can execute an application associated with the parallel reality game to enable interaction between the client device 110 and the server 120 or other components of the system environment 100 via the network 105. In another embodiment, the client device 110 interacts with the server 120 or other components of the system environment 100 through an application programming interface (API) running on a native operating system of the client device 110, such as IOS® or ANDROID™.

In one or more embodiments, the client device 110 communicates with the server 120, providing the server 120 with sensory data of a physical environment. The client device 110 includes a camera assembly 112 that captures image data in two dimensions of a scene in the physical environment where the client device 110 is. In the embodiment shown in FIG. 1, each client device 110 includes components such as a gaming module 114 and a positioning module 116. In an embodiment, the client device 110 further includes a localization module 118. The client device 110 may include various other input/output devices for receiving information from and/or providing information to a player. Example input/output devices include a display screen, a touch screen, a touch pad, data entry keys, speakers, and a microphone suitable for voice recognition. The client device 110 may also include additional sensors for recording data from the environment of the client device 110, the sensors including but not limited to, movement sensors, accelerometers, gyroscopes, other inertial measurement units (IMUs), barometers, positioning systems, thermometers, light sensors, microphones, etc.

The client device 110 can further include a network interface (not shown) for providing communications over the network 105. A network interface can include any suitable components for interfacing with one more networks, including for example, transmitters, receivers, ports, controllers, antennas, or other suitable components.

The camera assembly 112 captures image data of a scene of the environment where the client device 110 is in. The camera assembly 112 may utilize a variety of varying photo sensors with varying color capture ranges at varying capture rates. The camera assembly 112 may contain a wide-angle lens or a telephoto lens. The camera assembly 112 may be configured to capture single images or video as the image data. Additionally, the orientation of the camera assembly 112 could be parallel to the ground with the camera assembly 112 aimed at the horizon. The camera assembly 112 captures image data and shares the image data with the computing device on the client device 110. The image data can be appended with metadata describing other details of the image data including sensory data (e.g., temperature, brightness of environment) or capture data (e.g., exposure, warmth, shutter speed, focal length, capture time, etc.). The camera assembly 112 can include one or more cameras which can capture image data. In one instance, the camera assembly 112 comprises one camera and is configured to capture monocular image data. In another instance, the camera assembly 112 comprises two cameras and is configured to capture stereoscopic image data. In various other implementations, the camera assembly 112 comprises a plurality of cameras each configured to capture image data. Each camera of the camera assembly 126 may append each image with metadata, e.g., including camera parameters such as lens focal length, shutter speed, exposure values, etc.

The gaming module 114 provides a player with an interface to participate in the parallel reality game. The server 120 transmits game data over the network 105 to the client device 110 for use by the gaming module 114 at the client device 110 to provide local versions of the game to players at locations remote from the server 120. The server 120 can include a network interface for providing communications over the network 105. A network interface can include any suitable components for interfacing with one more networks, including for example, transmitters, receivers, ports, controllers, antennas, or other suitable components.

The gaming module 114 executed by the client device 110 provides an interface between a player and the parallel reality game. The gaming module 114 can present a user interface on a display device associated with the client device 110 that displays a virtual world (e.g., renders imagery of the virtual world) associated with the game and allows a user to interact in the virtual world to perform various game objectives. In some other embodiments, the gaming module 114 presents image data from the real world (e.g., captured by the camera assembly 112) augmented with virtual elements from the parallel reality game. In these embodiments, the gaming module 114 may generate virtual content and/or adjust virtual content according to other information received from other components of the client device 110. For example, the gaming module 114 may adjust a virtual object to be displayed on the user interface according to a depth map of the scene captured in the image data.

In one or more embodiments, the gaming module 114 may present a digitized spatial representation of a real-world scene. In such embodiments, the spatial representation may be previously generated from image data comprising a plurality of image frames of the real-world scene. The digitized spatial representation may capture the spatial structure of objects in the real-world scene. The representation may further include visual characteristics of the objects mapped onto the volumetric reconstruction. The visual characteristics may include a texture, a pattern, a coloration, topographical features, other visual features. In some embodiments, the gaming module 114 may adjust rendering on a display of the client device 110 based on a pose of the client device 110. For example, a player may move around the digitized spatial representation with their client device 110. Based on the movement, i.e., the changed pose of the client device 110, the gaming module 114 may update a perspective of the digitized spatial representation. Accordingly, the gaming module 114 may leverage the pose, e.g., from the localization module 118.

The gaming module 114 can also control various other outputs to allow a player to interact with the game without requiring the player to view a display screen. For instance, the gaming module 114 can control various audio, vibratory, or other notifications that allow the player to play the game without looking at the display screen. The gaming module 114 can access game data received from the server 120 to provide an accurate representation of the game to the user. The gaming module 114 can receive and process player input and provide updates to the server 120 over the network 105. The gaming module 114 may also generate and/or adjust game content to be displayed by the client device 110. For example, the gaming module 114 may generate a virtual element based on depth information.

The positioning module 116 can be any device or circuitry for monitoring the position of the client device 110. For example, the positioning module 116 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or other suitable techniques for determining position. The positioning module 116 may further include various other sensors that may aid in accurately positioning the client device 110 location.

As the player moves around with the client device 110 in the real world, the positioning module 116 tracks the position of the player and provides the player position information to the gaming module 114. The gaming module 114 updates the player position in the virtual world associated with the game based on the actual position of the player in the real world. Thus, a player can interact with the virtual world simply by carrying or transporting the client device 110 in the real world. In particular, the location of the player in the virtual world can correspond to the location of the player in the real world. The gaming module 114 can provide player position information to the server 120 over the network 105. In response, the server 120 may enact various techniques to verify the client device 110 location to prevent cheaters from spoofing the client device 110 location. It should be understood that location information associated with a player is utilized only if permission is granted after the player has been notified that location information of the player is to be accessed and how the location information is to be utilized in the context of the game (e.g., to update player position in the virtual world). In addition, any location information associated with players will be stored and maintained in a manner to protect player privacy.

The localization module 118 provides an additional or alternative way to determine the location of the client device 110. In one embodiment, the localization module 118 receives the location determined for the client device 110 by the positioning module 116 and refines it by determining a pose of one or more cameras of the camera assembly 112. The localization module 118 may use the location generated by the positioning module 116 to select a 3D map of the environment surrounding the client device 110 and localize against the 3D map. The localization module 118 may obtain the 3D map from local storage or from the server 120. The 3D map may be a point cloud, mesh, or any other suitable 3D representation of the environment surrounding the client device 110. Alternatively, the localization module 118 may determine a location or pose of the client device 110 without reference to a coarse location (such as one provided by a GPS system), such as by determining the relative location of the client device 110 to another device.

In one embodiment, the localization module 118 applies a trained relocalizer model (as an embodiment of a localization model) to determine the pose of images captured by the camera assembly 112 relative to the 3D map. Thus, the relocalizer model can determine an accurate (e.g., to within a few centimeters and degrees) determination of the position (e.g., up to three degrees of translational freedom) and orientation (e.g., up to three degrees of rotational freedom) of the client device 110. The position of the client device 110 can then be tracked over time using dead reckoning based on sensor readings, periodic re-localization, or a combination of both. Having an accurate pose for the client device 110 may enable the gaming module 114 to present virtual content overlaid on images of the real world (e.g., by displaying virtual elements in conjunction with a real-time feed from the camera assembly 112 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The server 120 can be any computing device and can include one or more processors and one or more computer-readable storage media. The computer-readable storage media can store instructions which cause the processor to perform operations. The server 120 can include or can be in communication with a database 115. The database 115 stores game data used in the parallel reality game to be served or provided to the client(s) 110 over the network 105.

The game data stored in the database 115 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) Game status (e.g. current number of players, current status of game objectives, player leaderboard, etc.); (7) data associated with player actions/input (e.g. current player positions, past player positions, player moves, player input, player queries, player communications, etc.); and (8) any other data used, related to, or obtained during implementation of the parallel reality game. The game data stored in the database 115 can be populated either offline or in real time by system administrators and/or by data received from users/players of the system 100, such as from a client device 110 over the network 105.

The server 120 can be configured to receive requests for game data from a client device 110 (for instance via remote procedure calls (RPCs)) and to respond to those requests via the network 105. For instance, the server 120 can encode game data in one or more data files and provide the data files to the client device 110. In addition, the server 120 can be configured to receive game data (e.g. player positions, player actions, player input, etc.) from a client device 110 via the network 105. For instance, the client device 110 can be configured to periodically send player input and other updates to the server 120, which the server 120 uses to update game data in the database 115 to reflect any and all changed conditions for the game.

In the embodiment shown, the server 120 includes a universal game module 130, a commercial game module 140, a data collection module 150, an event module 160, and a training system 170. As mentioned above, the server 120 interacts with a database 115 that may be part of the server 120 or accessed remotely (e.g., the database 115 may be a distributed database accessed via the network 105). In other embodiments, the server 120 contains different and/or additional elements. In addition, the functions may be distributed among the elements in a different manner than described. For instance, the database 115 can be integrated into the server 120.

The universal game module 130 hosts the parallel reality game for all players and acts as the authoritative source for the current status of the parallel reality game for all players. As the host, the universal game module 130 generates game content for presentation to players, e.g., via their respective client devices 110. The universal game module 130 may access the database 115 to retrieve and/or store game data when hosting the parallel reality game. The universal game module 130 also receives game data from client device 110 (e.g. depth information, player input, player position, player actions, landmark information, etc.) and incorporates the game data received into the overall parallel reality game for all players of the parallel reality game. The universal game module 130 can also manage the delivery of game data to the client device 110 over the network 105. The universal game module 130 may also govern security aspects of client device 110 including but not limited to securing connections between the client device 110 and the server 120, establishing connections between various client device 110, and verifying the location of the various client device 110.

The commercial game module 140, in embodiments where one is included, can be separate from or a part of the universal game module 130. The commercial game module 140 can manage the inclusion of various game features within the parallel reality game that are linked with a commercial activity in the real world. For instance, the commercial game module 140 can receive requests from external systems such as sponsors/advertisers, businesses, or other entities over the network 105 (via a network interface) to include game features linked with commercial activity in the parallel reality game. The commercial game module 140 can then arrange for the inclusion of these game features in the parallel reality game.

The server 120 can further include a data collection module 150. The data collection module 150, in embodiments where one is included, can be separate from or a part of the universal game module 130. The data collection module 150 can manage the inclusion of various game features within the parallel reality game that are linked with a data collection activity in the real world. For instance, the data collection module 150 can modify game data stored in the database 115 to include game features linked with data collection activity in the parallel reality game. The data collection module 150 can also analyze and data collected by players pursuant to the data collection activity and provide the data for access by various platforms.

The event module 160 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The training system 170 trains one or more models implemented by the client device 110 and/or the server 120. To train models, the training system 170 may obtain training data from one or more sources. The training data may be labeled (i.e., for supervised training), unlabeled (i.e., for unsupervised training), or some combination thereof (i.e., for semi-supervised training). Once trained, the training system 170 may validate the efficacy of the one or more models. The training system 170 may further fine tune (i.e., retrain) the one or more models based on validation data. In one or more embodiments, the training system 170 may train relocalizer model for estimating a camera pose of an input image, in reference to reconstructed physical scene in the real-world. In other embodiments, a relocalizer model may be deployed on the client device 110. The trained relocalizer model may be provided to the client device 110 and the localization module 118 may include functionality to load and initialize the relocalizer model on the client device 110 to perform inference.

The content generation module 180 generates content for presentation to the client device 110. In one or more embodiments, the content generation module 180 may be used to generate virtual reality, mixed reality, augmented reality content, or other artificial reality content.

In one or more embodiments of generating augmented reality content, the content generation module 180 generates virtual elements to overlay onto images captured of real-world environments or scenes. The content generation module 180 may generate the virtual element based on information on the images, e.g., pose, camera calibration, depth, image features, etc. In some embodiments, the pose may be used in other image featurization models, e.g., a depth estimation model configured to input an image and its pose to output a depth map for the image. The depth map may inform depth of various objects in the image, e.g., for generating virtual content that is at least partially occluded.

In one or more embodiments, the content generation module 180 may generate a digitized spatial representation of a physical scene. To create the digitized spatial representation, the content generation module 180 reconstructs volumetric representations of real-world objects in the physical scene. The content generation module 180 may form the volumetric representations based on pose information on the image data and, optionally, associated depth information. For example, the content generation module 180 may implement a truncated signed distance function (TSDF) to integrate depth maps with known pose to generate a three-dimensional (3D) voxel array representing surfaces of objects in the real-world scene. The content generation module 180 may further extract a polygon mesh from the 3D voxel array to represent the surfaces via discretizing polygons. The content generation module 180 may further augment the spatial representation with visual characteristics of the objects, obtained from the image data. The content generation module 180 may store the generated spatial representations in the database 115. At a later time, the content generation module 180 may update or refine the spatial representation of the real-world scene with additional image data on the scene. In some embodiments, the content generation module 180 may generate virtual elements to interact with the digitized spatial representation. For example, the content generation module 180 may overlay virtual characters, virtual modifications, etc. The server 120 may provide the digitized spatial representation, optionally with virtual elements, to the client device 110 for presentation to the user.

In some embodiments, the content generation module 180 may generate navigational instructions for navigating a traversable agent within an environment. In such embodiments, the client device 110 may be the traversable agent, e.g., an autonomous vehicle. Based on its movement mode, the content generation module 180 may generate control instructions to control operation of one or more actuator assemblies to move the traversable agent. The content generation module 180 may receive sensory data of the environment, e.g., image data (and associated data), depth information, etc. The content generation module 180 (or the client device 110) may further implement models to extract additional features from the sensory data, e.g., implementing a trained relocalizer model to output poses for the images of the image data. The content generation module 180 may further implement a depth estimation model to output depth information for the images of the image data. The content generation module 180 may further implement other models, an object detection model for identifying and/or recognizing objects in the image data, a semantic segmentation model for segregating pixels into different pixel categorizations (e.g., objects, ground, sky, buildings, transient or moving objects, etc.), etc. Based on the information deduced from the sensory data, the content generation module 180 may determine the navigational route of the traversable agent. In some embodiments, the content generation module 180 may provide the navigational instructions to the client device 110. In other embodiments, the content generation module 180 may generate control instructions to control the movement of the traversable agent.

The network 105 can be any type of communications network, such as a local area network (e.g. intranet), wide area network (e.g. Internet), or some combination thereof. The network can also include a direct connection between a client device 110 and the server 120. In general, communication between the server 120 and a client device 110 can be carried via a network interface using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In addition, in-situations in which the systems and methods discussed herein access and analyze personal information about users, or make use of personal information, such as location information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user’s identity may be treated so that no personally identifiable information can be determined for the user.

### Exemplary Game Interface

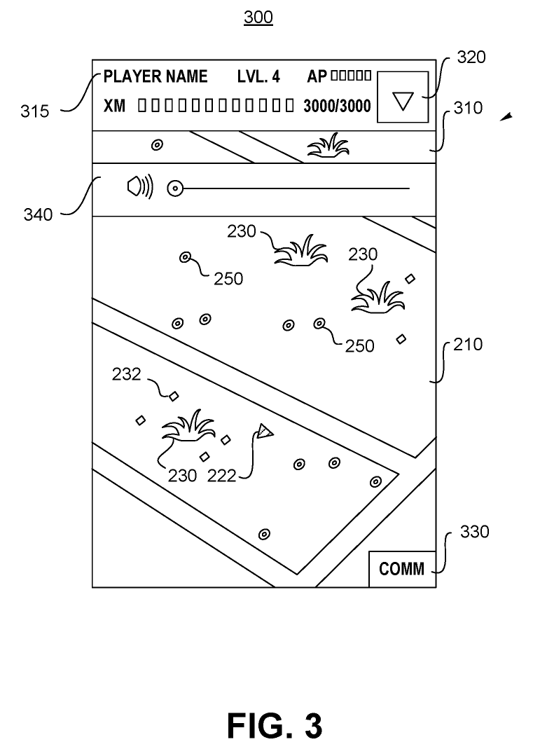

FIG. 3 depicts one embodiment of a game interface 300 that can be presented on a display of a client as part of the interface between a player and the virtual world 210. The game interface 300 includes a display window 310 that can be used to display the virtual world 210 and various other aspects of the game, such as player position 222 and the locations of virtual elements 230, virtual items 232, and virtual energy 250 in the virtual world 210. The user interface 300 can also display other information, such as game data information, game communications, player information, client location verification instructions and other information associated with the game. For example, the user interface can display player information 315, such as player name, experience level and other information. The user interface 300 can include a menu 320 for accessing various game settings and other information associated with the game. The user interface 300 can also include a communications interface 330 that enables communications between the game system and the player and between one or more players of the parallel reality game.

According to aspects of the present disclosure, a player can interact with the parallel reality game by simply carrying a client device 110 around in the real world. For instance, a player can play the game by simply accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 300 can include a plurality of non-visual elements that allow a user to interact with the game. For instance, the game interface can provide audible notifications to the player when the player is approaching a virtual element or object in the game or when an important event happens in the parallel reality game. A player can control these audible notifications with audio control 340. Different types of audible notifications can be provided to the user depending on the type of virtual element or event. The audible notification can increase or decrease in frequency or volume depending on a player’s proximity to a virtual element or object. Other non-visual notifications and signals can be provided to the user, such as a vibratory notification or other suitable notifications or signals.

Those of ordinary skill in the art, using the disclosures provided herein, will appreciate that numerous game interface configurations and underlying functionalities will be apparent in light of this disclosure. The present disclosure is not intended to be limited to any one particular configuration.

### Collaborative Authoring of an AR Experience

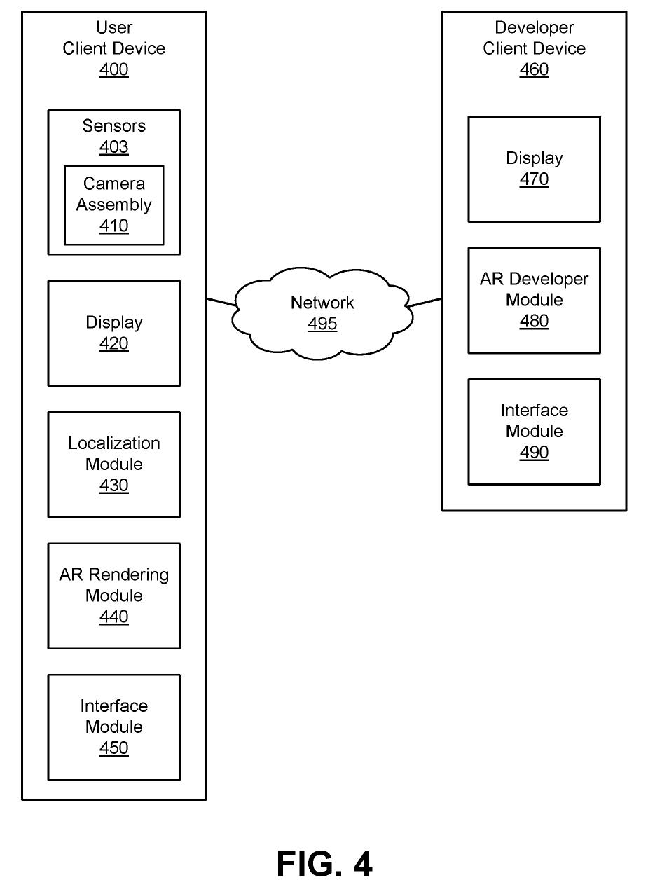

FIG. 4 illustrates a networked computing environment for collaborative authoring of an AR experience, according to one or more embodiments. The networked computing environment provides for the interaction of at least one user, operating a user client device 400, and at least one developer, operating a developer client device 460. The developer generates and updates an AR experience remotely, i.e., off-site, while the user provides feedback to the AR experience on-site. For convenience, various embodiments are described with reference to “the user’s location” but one of skill in the art will appreciate that such references may refer to the location of the user’s client device.

A in-situ user operates a user client device 400 to provide feedback to the developer on a site-specific AR experience. The user client device 400 may, in general, be a mobile device with less computational power than the developer client device 460. As such, the user client device 400 is less-situated for authoring the AR experience compared to the developer client device 460. The user client device 400 includes one or more sensors 403 (including a camera assembly 410), a display 420, a localization module 430, an AR rendering module 440, and an interface module 450. In other embodiments, the user client device 400 may include additional components, e.g., other input and/or output devices. For example, the user client device 400 may include a microphone for capturing audio, an audio speaker for presenting audio, etc.

The sensors 403 capture data in conjunction with operation of the client device 400. The sensors may capture data on the characteristics of the environment, e.g., images, depth, weather, global positioning coordinates, elevation, etc. The sensors may also capture data based on the user’s operation of the client device 400, e.g., speech, motion, etc.

The camera assembly 410 captures image data of the environment. The camera assembly 410 may include one or more cameras. Image data captured by the camera assembly 410 may be augmented with virtual content, thereby generating AR content. In some embodiments, the camera assembly 410 include at least two cameras, with one camera facing one direction (e.g., on the backside of a mobile phone), and another camera facing an opposite direction (e.g., on the frontside of the mobile phone). Each camera may include one or more optical elements for directing and focusing light from the environment onto an imaging sensor that converts the incident light into a digital signal, forming a digital image.

The display 420 presents visual content. The display 420 includes a hardware device such as a screen. The display 420 may present a live feed of the camera assembly 410. The display 420 may further present AR content augmented onto the live feed, e.g., via the AR rendering module 440. In various embodiments, the display 420 may be an integrated touchscreen configured to detect user input via capacitive, resistive, optical, ultrasonic, or other sensing modalities, and may support single- or multi-touch, stylus, and gesture interactions. Alternatively or additionally, the display 420 may be a non-touch monitor, panel, or screen, including but not limited to LCD, LED, OLED, microLED, plasma, CRT, e-paper/e-ink, projection surfaces, head-up displays, and head-mounted or near-eye displays (e.g., AR/VR). The display 420 may be internal to the device (e.g., a smartphone, tablet, or laptop) or external (e.g., a desktop monitor, television, kiosk, or digital signage), and may be connected via wired interfaces (e.g., HDMI, DisplayPort, USB-C, LVDS, MIPI) and/or wireless links (e.g., Wi-Fi-based casting, Miracast, AirPlay, Bluetooth). The display 420 may have any suitable size, resolution, aspect ratio, color depth, refresh rate, brightness, and orientation, and may operate as one of multiple displays in mirrored or extended configurations. In some embodiments, the display 420 includes or interfaces with a display controller, backlight, driver circuitry, and sensors such as ambient light, proximity, and orientation sensors, and may provide haptic output. The display 420 may be foldable, rollable, detachable, or remote (e.g., streamed), and may render graphical user interfaces, video, images, and text associated with operation of the user device.

In one or more embodiments, the sensors 403 include an inertial measurement unit (IMU). The IMU is configure to capture motion data describing motion of the user device. In various embodiments, the IMU includes one or more accelerometers and gyroscopes, and optionally magnetometers and barometric sensors, sampled at configurable rates with synchronized timestamps to produce raw linear acceleration, angular rate, and magnetic field measurements. The IMU may include on-board or host-executed signal processing that performs filtering (e.g., low-pass, high-pass, notch), bias and scale-factor correction, temperature compensation, and sensor fusion (e.g., complementary or Kalman filtering) to estimate device attitude (e.g., quaternion, rotation matrix, Euler angles), gravity-compensated linear acceleration, and angular velocity in device and/or world coordinate frames. The IMU may perform continuous or event-driven motion detection, including thresholded wake-on-motion, step or stride detection, gesture or tap recognition, and stationary versus dynamic state classification, and may transform measurements between sensor, device, and application reference frames using stored calibration and alignment parameters. In some embodiments, the IMU supports dead reckoning and pose tracking, provides disturbance detection (e.g., magnetic anomalies, shock events) and outlier rejection, and combines its outputs with auxiliary signals (e.g., GNSS, camera-based visual odometry, wheel encoders, or Wi-Fi/Bluetooth ranging) to improve accuracy and robustness. In certain implementations, the IMU operates in multiple modes (e.g., high-accuracy, low-power, game/AR), selected based on application requirements to balance precision, responsiveness, and resource usage.

In various embodiments, the sensors 403 includes a global positioning system receiver configured to determine global positioning coordinates of the client device 400. The global positioning system receiver may include a radiofrequency (RF) front end (e.g., antenna, low-noise amplifier, filters) and baseband processor configured to acquire and track satellite signals, correlate received waveforms with known pseudo-random noise codes, and extract navigation data (e.g., ephemeris, almanac, timing) from one or more satellites to determine global positioning coordinates. The receiver estimates code phase and carrier frequency using tracking loops (e.g., delay-locked, frequency-locked, phase-locked) to produce pseudorange and Doppler measurements, computes satellite positions from ephemerides, and performs trilateration while jointly solving for receiver clock bias to yield latitude, longitude, altitude, and optionally velocity and heading. In some implementations, the receiver supports multiple constellations and frequencies (e.g., GPS L1/L2/L5, GLONASS, Galileo, BeiDou), applies atmospheric models and error corrections, and leverages augmentation systems (e.g., SBAS, differential GPS, RTK) and assisted-GPS aiding (e.g., network-provided time, ephemeris, coarse location) to improve accuracy, convergence time, and availability. The receiver may implement multipath and interference mitigation, quality estimation (e.g., SNR, DOP, fix type, confidence bounds), and sensor fusion with inertial inputs for continuity during signal blockage. The receiver exposes standardized interfaces for configuration and data output (e.g., NMEA sentences or binary messages) and may provide timestamped coordinates aligned to GPS time or UTC, along with diagnostics and integrity indicators.

In various embodiments, the sensors 403 includes an acoustic sensor assembly configured to capture acoustic signals for voice input, communication, and ambient sound sensing. The acoustic sensor assembly may employ one or more microphones, e.g., analog or digital MEMS transducers with omnidirectional or directional patterns, coupled to an analog front end (e.g., low-noise amplifier, biasing, anti-alias filter) and an analog-to-digital converter, or implemented as digital microphones providing pulse-density modulation or I2S/TDM outputs.

The microphone may operate at selectable sample rates and bit depths, and can be arranged in arrays to support beamforming, spatial filtering, and direction-of-arrival estimation. Signal processing on-device may include automatic gain control, noise suppression, echo cancellation, wind and handling noise mitigation, de-reverberation, voice activity detection, and wake-word or keyword spotting, with configurable latency and power profiles. Placement and calibration strategies (e.g., sensitivity matching, phase alignment, temperature and aging compensation) can improve fidelity across device orientations and use cases, and adaptive algorithms may adjust parameters based on ambient conditions.

In various embodiments, the client device 400 includes an audio speaker configured to render acoustic output from a user device. The audio speaker may include one or more electroacoustic transducers such as dynamic drivers (moving-coil), balanced armature elements, planar magnetic or piezoelectric actuators, bone-conduction emitters, or micro-speaker arrays, arranged as single- or multi-way systems with passive or active crossovers. The audio speaker may be mounted in an engineered enclosure (e.g., sealed, vented/ported, transmission line, or with a passive radiator) with acoustic labyrinths, gaskets, and meshes to control resonance, reduce distortion, improve low-frequency extension, and provide environmental protection (e.g., water-resistant membranes and debris filters). The system may cooperate with microphones to support echo reference for voice capture and optional active noise control, and can run calibration or self-test routines (e.g., impulse response, sweep-based diagnostics) to compensate for manufacturing variance and aging.

The localization module 430 localizes a position of the user client device 400. The localization module 430 may use one or more relocalizer models to localize the position of the user client device 400. For example, the relocalizer model may be image-based, configured to determine a position of the user client device 400 based on the captured image data from the camera assembly 410. In other examples, the relocalizer model is configured to ingest other sensor data, e.g., IMU data, global positioning coordinates, or depth data, to predict the position of the user client device 400. The position of the user client device 400 may include information on a position of the user client device 400 in relation to the real-world site. The position of the user client device 400 may include information on up to 6 degrees-of-freedom (DOF), i.e., three spatial coordinates and three rotational coordinates. Example models for localization of a client device are described in U.S. Application No. 19/303,699 filed on September 12, 2025, U.S. Application No. 18/887,207 filed on September 17, 2024, U.S. Patent No. 12,390,734 issued on August 19, 2025, all of which are incorporated by reference.

The AR rendering module 440 renders the AR experience generated by the developer. The AR rendering module 440 may render the AR experience based on the position of the user client device 400. In one or more embodiments, the AR rendering module 440 may retrieve a digital spatial model of the real-world environment characterizing positions of objects, landmarks, and surface topography in the real-world environment. The spatial model may be a three-dimensional representation of the real-world environment. The spatial model may be a point cloud, a polygon mesh, or a heightfield. The AR experience may include instructions on rendering one or more virtual elements as an augmentation to the captured image data, i.e., AR content. The instructions may specify positions in the spatial model for placement of the virtual elements. The instructions may control behavior of the virtual elements when presented in the AR experience. For example, the instructions include generation of a virtual creature pinned to spawn at a position in the spatial model. The instructions may further specify that, upon user interaction (e.g., user tapping the display where the virtual creature is displayed, or speaking to the virtual creature), the virtual creature performs a gesture. In rendering the AR experience, the AR rendering module 440 may render the AR content based on the captured image data, e.g., to match tone, exposure levels, etc. The AR rendering module 440 may present the rendered AR content on the display 420.

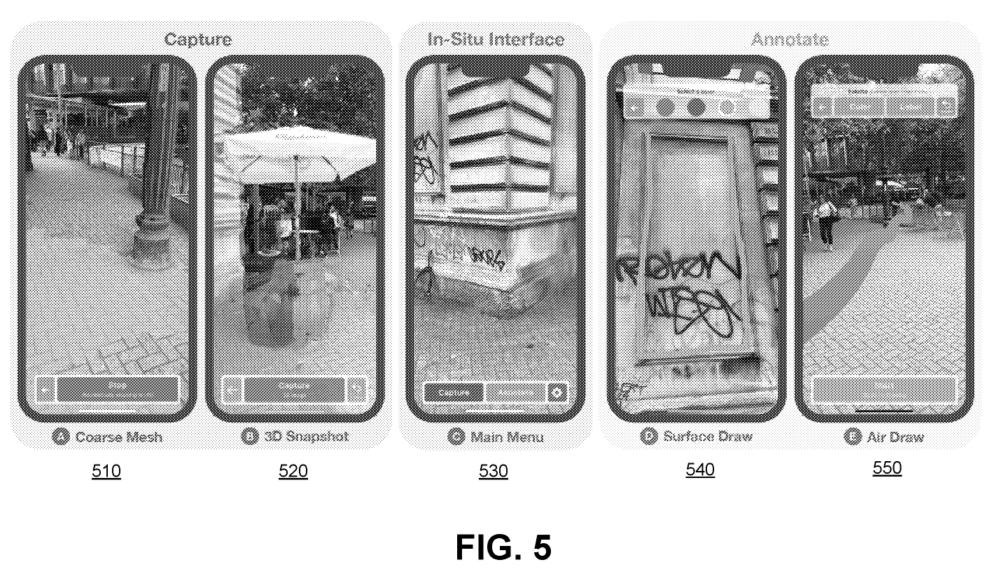

The interface module 450 generates a user interface on the display 420 for interaction with the developer client device 460. The interface module 450 may layer the user interface atop the AR experience. The interface module 450 includes one or more options for inputting commentary by the in-situ user. For example, the interface module 450 may include an option to draw on the display 420, or for recording handwritten notes or other indicia. Upon the user selection of the option, the interface module 450 may present a virtual stylus for writing notes on a notepad or overlaid onto the AR experience. The notes may be appended to the position of the client device 400 in the spatial model when the note was taken, or may be collated with other notes in a report. The interface module 450 may include an option to capture an audio byte, e.g., via a microphone on the user client device 400. Upon the user selection of the option, the interface module 450 records the audio byte with the microphone on the user client device 400. The interface module 450 stores the audio byte in association with the AR experience. The interface module 450 may include another option to label various points of interest in the site, e.g., labeling a path as currently obstructed, labeling an object as being in a different position, etc. The interface module 450 gathers the input from the user as commentary to the AR experience. The interface module 450 provides the commentary to the developer client device 460 for informing updates to the AR experience. Example interfaces are illustrated and further described in FIG. 5.

In one or more embodiments, the interface module 450 provides a real-time communication link between the user client device 400 and the developer client device 460. The communication link may be an audio call, a video call, or some combination thereof. Either device may initiate the connection, with the other device with the option to accept the connection. Upon establishment of the communication link, the interface module 450 may stream data between the devices, e.g., providing audio or video between the devices. Providing the real-time communication link empowers the ex-situ developer to see how the AR experience is rendered to the in-situ user.

The developer client device 460 generates and updates the AR experience. The developer client device 460 may be more computationally powerful than the user client device 400, i.e., useful for authoring the AR experience. The developer client device 460 may include a display 470, an AR developer module 480, and an interface module 490. In other embodiments, the user client device 400 may include additional components.

The display 470 presents visual content to the ex-situ developer. The display 470 may present different windows with different tools for authoring of the AR experience. In various embodiments, the display 470 may be an integrated touchscreen configured to detect user input via capacitive, resistive, optical, ultrasonic, or other sensing modalities, and may support single- or multi-touch, stylus, and gesture interactions. Alternatively or additionally, the display 470 may be a non-touch monitor, panel, or screen, including but not limited to LCD, LED, OLED, microLED, plasma, CRT, e-paper/e-ink, projection surfaces, head-up displays, and head-mounted or near-eye displays (e.g., AR/VR). The display 470 may be internal to the device (e.g., a smartphone, tablet, or laptop) or external (e.g., a desktop monitor, television, kiosk, or digital signage), and may be connected via wired interfaces (e.g., HDMI, DisplayPort, USB-C, LVDS, MIPI) and/or wireless links (e.g., Wi-Fi-based casting, Miracast, AirPlay, Bluetooth). The display 470 may have any suitable size, resolution, aspect ratio, color depth, refresh rate, brightness, and orientation, and may operate as one of multiple displays in mirrored or extended configurations. In some embodiments, the display 470 includes or interfaces with a display controller, backlight, driver circuitry, and sensors such as ambient light, proximity, and orientation sensors, and may provide haptic output. The display 470 may be foldable, rollable, detachable, or remote (e.g., streamed), and may render graphical user interfaces, video, images, and text associated with operation of the user device.

The AR developer module 480 includes a suite of one or more tools for authoring of the AR experience. For example, the AR developer module 480 may a pre-generated spatial model of a real-world site. The spatial model may be generated by scans from one or more camera assemblies. The scans may be leveraged to build the spatial model, which may describe positions of objects and other surfaces at the real-world site. The AR developer module 480 may also refine the spatial model based on data received by the user client device 400. For example, the AR developer module 480 may receive scans of a portion of the real-world site, which may be fused with the data in the spatial model.

The AR developer module 480 may further include a library of virtual elements that may be added into the AR experience. These virtual elements may be generated by the developer, or provided by another database. From the database of virtual elements (e.g., 3D models, decals, text, particle systems, audio/haptic cues), the AR developer can select elements to add into an AR experience, each element being associated with metadata fields defining spatial anchors, spawn rules, behaviors, and dependencies. Elements may be tagged with location descriptors such as latitude/longitude, altitude, coordinate reference system identifiers, geofenced regions (e.g., circular, polygonal, corridor), place identifiers (e.g., points of interest), and indoor references (e.g., floor level, room identifiers), along with constraints on orientation, scale, and visibility. At runtime, the AR developer module 480 resolves these tags using device context (e.g., GNSS coordinates, inertial pose estimates, visual mapping, network-based positioning) to determine when and where elements should spawn, computes world-space transforms, and anchors elements to stable references (e.g., geo-anchors, locally detected surfaces, persistent map features). The AR developer module 480 can further define animations and virtual element behaviors via timelines, state machines, behavior graphs, or scripts, supporting transitions, looping, event-triggered actions, physics interactions, occlusion handling, proximity or gaze responses, and time-of-day or condition-based logic.

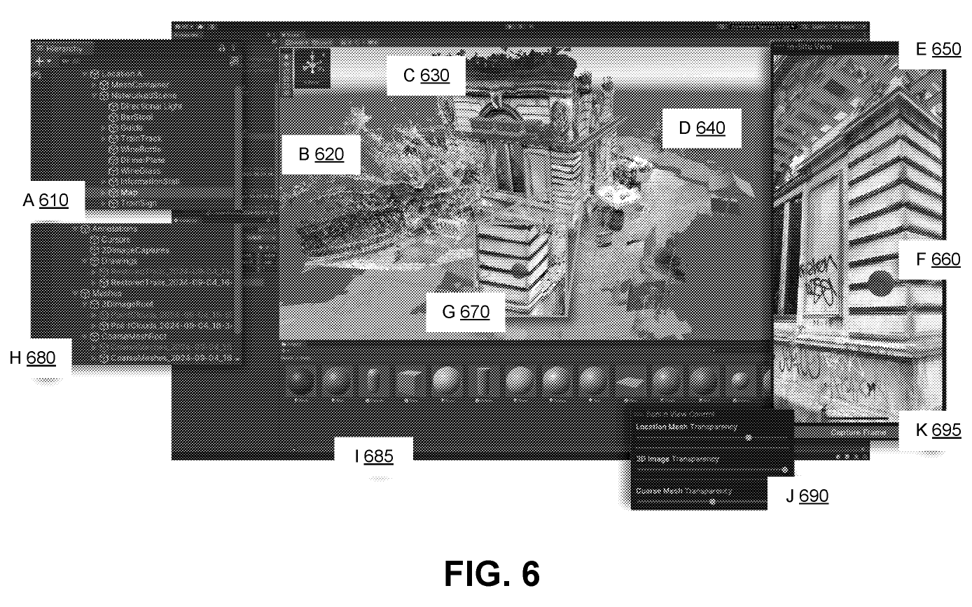

The interface module 490 generates a user interface on the display 470 for interaction with the user client device 400. The user interface (i.e., for the developer) may present the spatial model of the real-world site, with any virtual elements added into the AR experience. The user interface may further present commentary received from the user client device 400, e.g., appended to the spatial model. For example, if the user client device 400 drew on a surface at a particular position in the real-world site, the hand-drawn indicia could be appended to a portion of the spatial model corresponding to the surface of the real-world site. The user interface may further include a feed of the display 420 on the user client device 400. This may empower real-time visibility into the real-world site and/or the AR experience for the ex-situ developer. An example interface is illustrated and described in FIG. 6.

FIG. 5 illustrates example user interfaces for an in-situ user’s client device 400, according to one or more embodiments. The user interface may present a menu of options, e.g., a main screen (e.g., as shown in example 530) may include two options: “Capture” and “Annotate”. In response to the user selection of the “Capture” option, the user interface may present additional options for types of data to be captured by the user client device. In example 510, the user interface may include an option for capturing a mesh of the real-world site. As the device captures the image data of the real-world site, the device generates a mesh of the surfaces in the real-world site. In example 520, the user interface may include an option for capturing a 3D image. In response to the user selection of the “Annotate” option, the user interface may present tools for annotating the live camera feed. For example, the user may use pen-like tool to mark up the live camera feed. In example 540, the user may draw on surfaces captured in the live camera feed, which the device may append to the surface. In example 550, the user may draw in the air, tracking along a path through the real-world site.

FIG. 6 illustrates an example user interface for an ex-situ developer’s client device 460, according to one or more embodiments. The example user interface may present a suite of tools for use by the ex-situ developer. For example, Window A 610 may include a list of virtual elements added into the AR experience, synchronized between the two client devices. A middle window may present the spatial model of the real-world site with any commentary appended to the model. Element B 620 may be image data captured by the in-situ user. Element C 630 may include a pre-generated mesh of the location. Element D 640 is a coarse mesh captured by the user’s client device. Window E 650 presents a live feed of the user client device’s display. Element F 660 is an annotation or cursor of the in-situ user. Element G 670 in the spatial model window corresponds to the position of the cursor of the in-situ user. Window H 680 includes data received by the user client device, including spatial captures and/or annotations. Window I 685 is a library of virtual elements that may be added to the AR experience. Window J 690 provides toggles for adjusting transparency of different data in the spatial model, e.g., the location mesh, the 3D image, and the coarse mesh. Element K 695 presents option to capture a frame from the feed of the in-situ user client device.

In various embodiments, interfacing an in-situ user at the site of an augmented reality experience with an ex-situ AR developer provides a bidirectional feedback loop that materially improves reliability, safety, and usability across a broad spectrum of real-world issue types. The interface can stream contextual telemetry (e.g., device pose, localization confidence, ambient lighting and noise levels, occlusion maps, performance metrics) and support structured annotations from the in-situ user, enabling the remote developer to diagnose and remediate issues in near real time without requiring physical presence. This configuration yields reduced time-to-resolution, fewer site revisits, and higher experience quality, as the developer can observe conditions as they occur, apply targeted updates, and validate outcomes immediately with the user.

Advantages can include mitigation of physical constraints and user safety hazards. For example, when the in-situ user encounters blocked paths, restricted areas, or hazardous environments, the interface allows the developer to modify geofences, alter spawn rules, adjust navigation cues, inject warnings or rerouting logic, or the like to reflect the current site conditions. Dynamic adjustments to element placement and interaction flows can be deployed while the user remains on site, minimizing exposure to risk and ensuring compliance with safety protocols and local regulations. This coupling of real-time site observations with remote authoring capabilities improves resilience of the experience to temporary or evolving physical constraints.

The interface can also improve alignment and registration of AR elements. Misaligned content due to misplaced anchors, occlusions, or perspective issues can be identified by the user and corroborated with sensor data. The developer can then retarget anchors, refine world-space transforms, update occlusion handling, and recalibrate tracking parameters to restore visual coherence. In situations where localization and tracking degrade, the developer can push alternative anchoring strategies, refine initialization procedures, or adjust sensor fusion thresholds, leading to faster recovery and more stable overlays. Contextual signals such as lighting and environmental noise enable the developer to adapt rendering, contrast, audio prompts, and interaction semantics to match the immediate conditions, thereby improving legibility and responsiveness.

Performance and interaction quality can be enhanced through remote tuning based on the device’s processing and rendering capabilities and the user’s movement patterns. Telemetry describing frame rate, thermal headroom, memory pressure, and shader load enables the developer to adjust level-of-detail, animation complexity, streaming policies, and update rates to maintain fluid interactions on constrained hardware. Observations of user position, gaze, and perspective allow the developer to reconfigure interaction affordances, hit testing regions, and UI layout to preserve intended user flow and reduce friction in task completion, even as site geometry or crowd density changes.

The interface can also improve social-cultural appropriateness and semantic fidelity. Feedback from the in-situ user regarding local customs, signage, sensitivities, or prohibited content allows the developer to substitute assets, alter messaging, and enforce exclusion zones to align the experience with community norms. When the system misrecognizes objects or fails to capture relevant semantics, the user can flag errors and provide corrective labels that the developer uses to update recognition models, adjust detection thresholds, or refine object

ontologies. These corrections can be propagated to other sites and scenarios, yielding cumulative improvements in semantic interaction quality.

Operationally, the interface supports continuous optimization through versioned updates, audit trails of changes, and structured categorization of issues for triage and prioritization. By closing the loop between on-site experience and remote authoring, organizations can reduce deployment cycles, lower support costs, and scale experiences to diverse environments with greater confidence. The resulting system increases robustness to environmental variability, enhances user safety and satisfaction, and delivers higher-fidelity AR content that remains aligned with real-world constraints and expectations.

### Example Methods

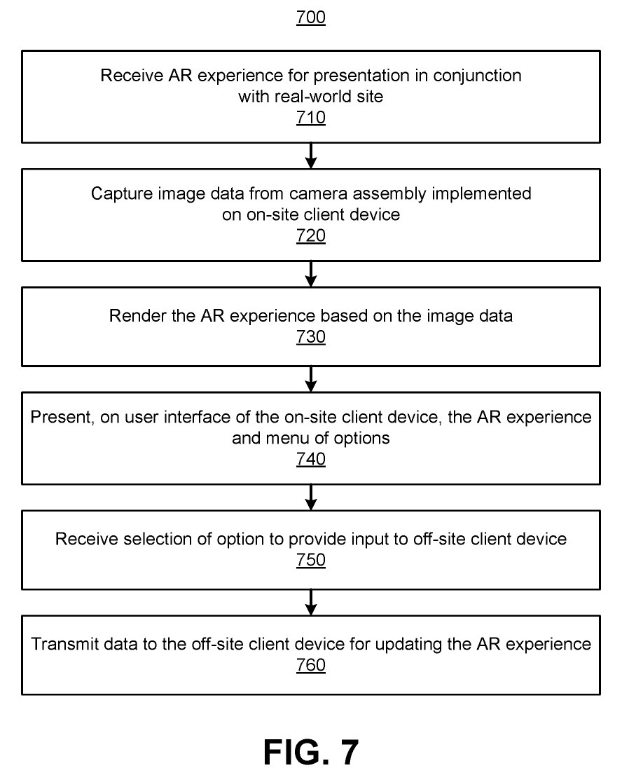

FIG. 7 illustrates a method flowchart describing a process 700 of in-situ collaboration in AR authoring, according to one embodiment. The process 700 may be performed by an on-site client device (e.g., the user client device 400 of FIG. 4). In other embodiments, one or more steps of the process 700 may be performed by another computing device. In other embodiments, the process 700 may include additional, fewer, or different steps than those listed herein.

The device receives 710 an AR experience for presentation in conjunction with a real-world site. In some implementations, the device authenticates with a content service and retrieves a package containing assets, spawn rules, geofences, and anchor metadata tied to the target site, performing integrity checks and version negotiation. The package may include dependencies, localization data, and policy constraints, which the device stores in a local cache and indexes for rapid access. Configuration parameters can specify allowed sensors, privacy settings, and update channels, enabling the device to tailor subsequent processing to site-specific requirements.

The device captures 720 image data from a camera assembly implemented on on-site client device. The capture pipeline may coordinate multiple sensors (e.g., RGB, depth, fisheye) with exposure, white balance, and focus control to produce timestamped frames and auxiliary calibration data. The device can apply rolling-shutter correction, lens distortion removal, and noise reduction, and may fuse IMU readings to stabilize imagery and support robust feature detection. To conserve bandwidth and power, the device can adapt frame rate and resolution to ambient lighting and motion, while buffering keyframes for downstream analysis and annotation.

The device renders 730 the AR experience based on the image data. A tracking subsystem estimates device pose and reconstructs local geometry to align virtual elements with the observed scene, computing world-space transforms from anchors, feature points, and geo-references. The rendering engine applies lighting estimation, occlusion masks, and level-of-detail policies to produce visually coherent overlays, while enforcing spawn constraints, proximity rules, and safety boundaries. Dynamic behaviors, animations, and physics interactions are scheduled according to timeline and state-machine definitions included in the AR experience package. In rendering the AR experience, the device may apply a relocalizer model to output a pose of the client device based at least in part on the image data.

The device presents 740, on user interface of the on-site client device, the AR experience and menu of options. The UI may include controls for reporting issues, capturing snapshots, annotating content, toggling rendering modes, and requesting assistance from an off-site developer. Contextual prompts may guide the user through diagnostics and validation tasks, while non-intrusive overlays display performance indicators, localization confidence, and safety notices. Accessibility features and multi-modal input (e.g., touch, voice, gesture) enable reliable interaction across diverse environments.

The menu of options presented on the user interface of the on-site client device may include a first option for providing annotations to the AR experience, which, when selected, activates an annotation capture workflow that binds user input to the currently visible virtual elements and site anchors. In some embodiments, capturing annotations from the user of the on-site client device comprises capturing, via a touchscreen display, a handwritten note by the user (e.g., finger or stylus strokes sampled with position, pressure, and timing), and storing the handwritten note in association with the pose of the on-site client device, such as the device’s position and orientation in a world or anchor coordinate frame with synchronized timestamps. In other embodiments, capturing annotation from the user of the on-site client device comprises capturing, via a microphone, an audio byte of the user, which the device encodes and stores with metadata including time, location, and pose so the audio annotation can be replayed or transcribed in context of the AR experience. The annotation option may further provide controls for preview, edit, and submission, and upon confirmation the device packages the annotations with integrity and provenance data for use by remote authoring systems to update or correct the AR content.

The device receives 750 selection of an option to provide input to off-site client device. Upon detecting the selection, the device launches a structured feedback workflow that captures evidence such as images, short video clips, audio notes, and positional logs, and associates them with the currently visible virtual elements and anchors. The device may categorize the input using predefined issue types, attach environment descriptors (e.g., lighting level, motion state, network quality), and redact sensitive content per user or policy settings. Collected artifacts are serialized into a report with integrity signatures and provenance metadata.

The device transmits 760 data to the off-site client device for updating the AR experience. The transmission can occur over secure channels with retry, acknowledgement, and delta compression to minimize latency and bandwidth usage, and may use priority queues to expedite critical safety-related reports. The off-site client device can respond with patches, parameter updates, or revised assets; upon receipt, the device validates and applies updates atomically and logs changes for auditability. If conflicts or rollbacks are required, the device may preserve prior versions and offers the user a prompt to re-test the corrected AR experience.

The menu of options presented on the user interface of the on-site client device may include a first option for providing annotations to the AR experience, which, when selected, activates an annotation capture workflow that binds user input to the currently visible virtual elements and site anchors. In some embodiments, capturing annotations from the user of the on-site client device comprises capturing, via a touchscreen display, a handwritten note by the user (e.g., finger or stylus strokes sampled with position, pressure, and timing), and storing the handwritten note in association with the pose of the on-site client device, such as the device’s position and orientation in a world or anchor coordinate frame with synchronized timestamps. In other embodiments, capturing annotation from the user of the on-site client device comprises capturing, via a microphone, an audio byte of the user, which the device encodes and stores with metadata including time, location, and pose so the audio annotation can be replayed or transcribed in context of the AR experience. The annotation option may further provide controls for preview, edit, and submission, and upon confirmation the device packages the annotations with integrity and provenance data for use by remote authoring systems to update or correct the AR content.

The menu of options may include a second option for capturing data corresponding to the real-world site, and presenting the menu of options comprises presenting this second option to the user. Upon receiving selection of the second option from the menu of options, the device initiates a capture workflow that records site telemetry and visual context and transmits the data to an off-site client device for updating of the AR experience. In some embodiments, capturing the data comprises generating a three-dimensional spatial representation of the real-world environment from the image data captured by the camera assembly, for example by estimating device pose and reconstructing a point cloud or mesh via stereo, structure-from-motion, or depth fusion, with surfaces labeled and aligned to the AR coordinate frame. In certain implementations, transmitting the data to the off-site client device comprises transmitting a live feed of the AR experience rendered on the on-site client device, including the camera view with overlaid virtual elements, status indicators, and timing metadata, encoded for low-latency streaming so the remote system can observe conditions, validate alignment, and apply patches in real time.

The menu of options may include a third option for establishing a communication link between the on-site client device and the off-site client device, and presenting the menu of options comprises presenting this third option to the user. Upon receiving selection of the third option from the menu of options, the on-site client device initiates session setup with the off-site client device and, responsive to the selection of the third option, establishes the communication link over authenticated and encrypted transport. In some embodiments, the communication link is an audio call, a video call, or a combination thereof, with adaptive media negotiation selecting codecs, bitrates, and resolution based on current network conditions; audio calls employ the device’s microphone and speaker with echo cancellation and noise suppression, while video calls stream the camera feed and optionally the AR overlay or screen content with jitter buffering and latency control. The link may support seamless downgrades from video to audio when bandwidth is constrained and upgrades back to video when conditions improve, while maintaining session continuity. Contextual metadata such as timestamps, device pose, and user annotations can accompany the media stream to enable the off-site client device to provide real-time guidance and apply updates to the AR experience.

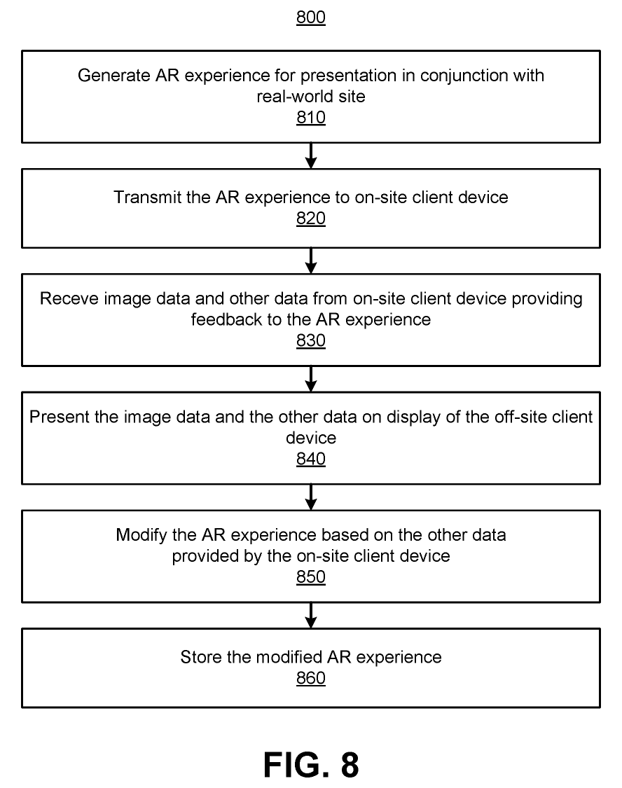

FIG. 8 illustrates a method flowchart describing a process 800 of ex-situ collaboration in AR authoring, according to one embodiment. The process 800 may be performed by an off-site client device (e.g., the developer client device 460 of FIG. 4). In other embodiments, one or more steps of the process 800 may be performed by another computing device. In other embodiments, the process 800 may include additional, fewer, or different steps than those listed herein.

The device generates 810 an AR experience for presentation in conjunction with a real-world site. In some embodiments, the device composes an experience package that includes virtual assets, spatial anchors, spawn rules, occlusion geometry, behavior graphs, safety geofences, and localization hints tied to site identifiers and coordinate frames. The package may encode compatibility profiles for target hardware, language/localization resources, and analytics and privacy policies. A build pipeline validates references, optimizes meshes and textures, derives collision and navigation data, and produces a signed manifest with checksums and dependency metadata to support secure distribution and reproducible deployment.

The device transmits 820 the AR experience to on-site client device. Transmission may occur via a secure channel using authenticated sessions, delta updates, and content-addressable caching to minimize bandwidth and enable resumable downloads. The device can negotiate versions and capabilities with the on-site client, select appropriate compression and streaming parameters, and stage assets for atomic activation to avoid partial installs. In certain implementations, a content delivery network or peer cache is leveraged to reduce latency, while policy controls restrict distribution to authorized devices and sites.

The device receives 830 image data and other data from on-site client device providing feedback to the AR experience. The incoming stream can include timestamped camera frames, depth or point clouds, device pose, localization confidence, performance metrics, and user-supplied artifacts such as annotations, audio notes, or issue codes. The device validates provenance, applies rate control and compression, and performs optional redaction of sensitive regions prior to storage or display. Data may be organized by session, site, and anchor identifiers to facilitate triage and correlation with previously deployed assets.

The other data may include other sensor data captured by one or more sensors of the on-site client device. For example, the on-site client device may provide inertial measurement unit outputs such as accelerometer, gyroscope, and magnetometer readings with synchronized timestamps, which the system uses to estimate pose, detect motion events, and refine anchor registration; global positioning coordinates from a satellite positioning receiver (e.g., GPS, GLONASS, Galileo, BeiDou) indicating latitude, longitude, altitude, and velocity; barometric pressure for floor-level estimation; ambient light sensor measurements for exposure and contrast adaptation; proximity and depth sensors (e.g., LiDAR, time-of-flight) for generating occlusion masks, surface meshes, and obstacle detection; thermal sensors and battery telemetry for throttling rendering or enabling safety prompts; microphone-derived audio levels and spectral features for determining noise conditions and selecting appropriate audio cues; network quality metrics (e.g., bandwidth, latency, packet loss) for adjusting streaming and synchronization rates; and camera-specific diagnostics such as focus distance, exposure, and lens distortion parameters.

In some implementations, the device aggregates the sensor data with quality indicators (e.g., covariance estimates, confidence scores), associates the data with site and anchor identifiers, and performs filtering, bias correction, and fusion to produce higher-level descriptors such as stability of localization, likelihood of occlusion, or hazard proximity. The sensor data may be used to automatically trigger annotations, modify spawn rules, adapt animations and interaction affordances, or request developer intervention when thresholds are exceeded, and may be redacted or quantized per privacy policies before transmission to the off-site client device.

The other data may include one or more annotations from a user of the on-site client device. For example, the device may capture, via a touchscreen display, a handwritten note created with finger or stylus strokes, and store the note in association with the device pose, anchor identifier, and timestamp so the annotation is recoverable in the same spatial context during later review. The device may additionally capture, via a microphone, an audio byte of the user that is encoded and linked to the current camera view and pose, with optional transcription to searchable text. Other annotation types can include typed comments, ratings or severity levels, snapshots or short video clips of the scene, and 2D or 3D markups such as arrows, bounding boxes, and freehand drawings that are anchored to surfaces, geo-anchors, or specific virtual elements. Each annotation may carry metadata including issue category, suggested remediation, environmental descriptors (e.g., lighting, noise, localization confidence), and provenance and integrity indicators, and may be previewed, edited, or redacted prior to submission. The device packages these annotations and synchronizes them with the off-site client device, enabling remote authors to inspect evidence in context, correlate reports with deployed assets, and generate targeted updates to the AR experience.

The device presents 840 the image data and the other data on display of the off-site client device. A developer console or dashboard renders the live or recorded camera view with current AR overlays, shows telemetry panels for tracking quality and frame rate, and highlights flagged elements or misalignments. Timeline and map views allow scrubbing through events, inspecting anchor stability, measuring distances, and comparing before/after states. Interfaces support filtering by issue type and opening contextual editors directly from selected scene objects or annotations.

The device modifies 850 the AR experience based on the other data provided by the on-site client device. Using the presented evidence, the device enables adjustments to anchor placement, spawn conditions, occlusion masks, lighting parameters, interaction affordances, and semantic labels, as well as performance-oriented changes such as level-of-detail or shader substitutions. Proposed edits can be simulated against captured frames or reconstructed geometry to verify alignment prior to deployment. Once validated, the device generates a patch or new version and prepares rollout instructions and feature flags for targeted testing with the on-site client.

The device stores 860 the modified AR experience. In one embodiment, the storage system maintains versioned artifacts, diffs, and audit metadata including authorship, timestamps, upstream evidence links, and test results, enabling rollback and provenance tracking. Redundant replication and integrity checks ensure availability and tamper resistance, while indexing by site, anchor, and asset type accelerates retrieval for future sessions. Policies may mark stable releases for broader distribution and retain experimental branches for continued iteration without disrupting deployed experiences. The device may transmit the modified AR experience for subsequent rendering and presentation on other on-site devices.

### Example Computing System

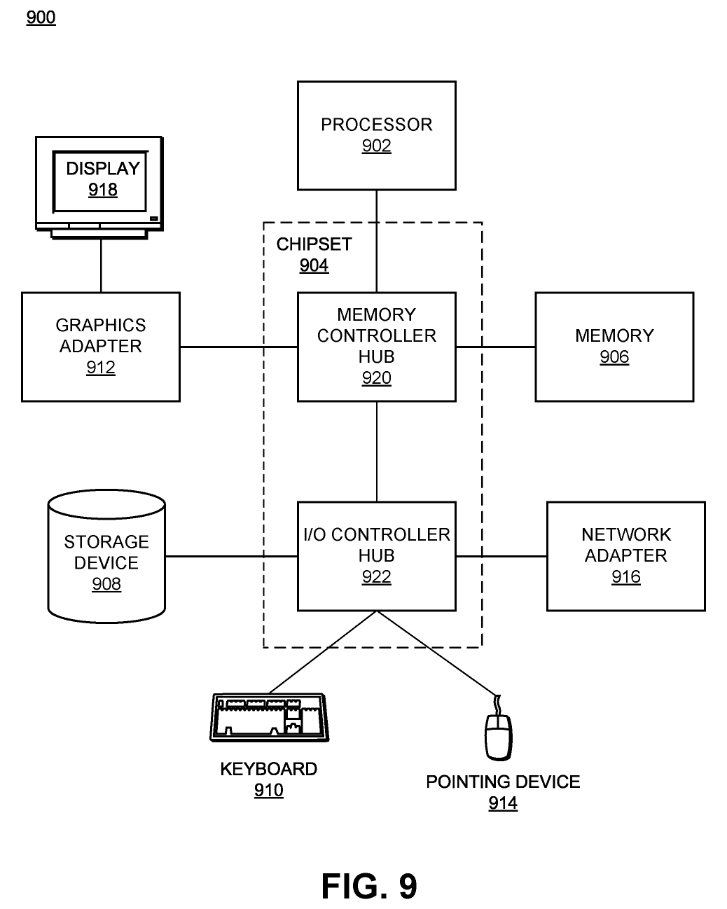

FIG. 9 is an example architecture of a computing device, according to an embodiment. Although FIG. 9 depicts a high-level block diagram illustrating physical components of a computer used as part or all of one or more entities described herein, according to an embodiment, a computer may have additional, less, or variations of the components provided in FIG. 9. Although FIG. 9 depicts a computer 900, the figure is intended as functional description of the various features which may be present in computer systems than as a structural schematic of the implementations described herein. In practice, and as recognized by those of ordinary skill in the art, items shown separately could be combined and some items could be separated.

Illustrated in FIG. 9 are at least one processor 902 coupled to a chipset 904. Also coupled to the chipset 904 are a memory 906, a storage device 908, a keyboard 910, a graphics adapter 912, a pointing device 914, and a network adapter 916. A display 918 is coupled to the graphics adapter 912. In one embodiment, the functionality of the chipset 904 is provided by a memory controller hub 920 and an I/O hub 922. In another embodiment, the memory 906 is coupled directly to the processor 902 instead of the chipset 904. In some embodiments, the computer 900 includes one or more communication buses for interconnecting these components. The one or more communication buses optionally include circuitry (sometimes called a chipset) that interconnects and controls communications between system components.

The storage device 908 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 908 can also be referred to as persistent memory. The pointing device 914 may be a mouse, track ball, or other type of pointing device, and is used in combination with the keyboard 910 to input data into the computer 900. The graphics adapter 912 displays images and other information on the display 918. The network adapter 916 couples the computer 900 to a local or wide area network.

The memory 906 holds instructions and data used by the processor 902. The memory 906 can be non-persistent memory, examples of which include high-speed random-access memory, such as DRAM, SRAM, DDR RAM, ROM, EEPROM, flash memory.

As is known in the art, a computer 900 can have different and/or other components than those shown in FIG. 9. In addition, the computer 900 can lack certain illustrated components. In one embodiment, a computer 900 acting as a server may lack a keyboard 910, pointing device 914, graphics adapter 912, and/or display 918. Moreover, the storage device 908 can be local and/or remote from the computer 900 (such as embodied within a storage area network (SAN)).

As is known in the art, the computer 900 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 908, loaded into the memory 906, and executed by the processor 902.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a computer system and a computerized process. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

What is claimed is:

1. A computer-implemented method comprising:
receiving, by an on-site client device, an augmented reality (AR) experience for presentation in conjunction with a real-world site;
capturing image data from a camera assembly of the on-site client device;
rendering the AR experience based on the image data captured by the on-site client device;
presenting, on a user interface of the on-site client device, the AR experience and a menu of options comprising a first option for providing annotations to the AR experience;
receiving selection of the first option from the menu of options;
responsive to the selection of the first option, capturing annotations from a user of the on-site client device; and
transmitting the annotations to an off-site client device for updating the AR experience.

2. The computer-implemented method of claim 1, wherein capturing annotations from the user of the on-site client device comprises:
capturing, via a touchscreen display, a handwritten note by the user; and
storing the handwritten note in association with a pose of the on-site client device.

3. The computer-implemented method of claim 1, wherein capturing annotation from the user of the on-site client device comprises:
capturing, via a microphone, an audio byte of the user.

4. The computer-implemented method of claim 1, wherein presenting the menu of options comprising presenting a second option in the menu of options for capturing data corresponding to the real-world site, the computer-implemented method further comprising:
receiving selection of the second option from the menu of options;
responsive to the selection of the second option, capturing data corresponding to the real-world site; and
transmitting the data to an off-site client device for updating of the AR experience.

5. The computer-implemented method of claim 4, wherein capturing the data comprises generating a three-dimensional spatial representation of the real-world site from the image data captured by the camera assembly.

6. The computer-implemented method of claim 4, wherein transmitting the data to the off-site client device comprises transmitting a live feed of the AR experience rendered on the on-site client device.

7. The computer-implemented method of claim 1, further comprising:
determining a pose of the on-site client device by applying a relocalizer model to the image data to output the pose, wherein the AR experience is rendered based on the pose of the on-site client device.

8. The computer-implemented method of claim 1, wherein presenting the menu of options comprising presenting a third option in the menu of options for establishing a communication link between the on-site client device and the off-site client device, the computer-implemented method further comprising:
receiving selection of the third option from the menu of options; and
responsive to the selection of the third option, establishing the communication link.

9. The computer-implemented method of claim 8, wherein the communication link is an audio call, a video call, or a combination thereof.

10. A non-transitory computer-readable storage medium storing instructions that, when executed, cause an on-site client device to perform operations comprising:
receiving an augmented reality (AR) experience for presentation in conjunction with a real-world site;
capturing image data from a camera assembly of the on-site client device;
rendering the AR experience based on the image data captured by the on-site client device;
presenting, on a user interface of the on-site client device, the AR experience and a menu of options comprising a first option for providing annotations to the AR experience;
receiving selection of the first option from the menu of options;
responsive to the selection of the first option, capturing annotations from a user of the on-site client device; and
transmitting the annotations to an off-site client device for updating the AR experience.

11. The non-transitory computer-readable storage medium of claim 10, wherein capturing annotations from the user of the on-site client device comprises:
capturing, via a touchscreen display, a handwritten note by the user; and
storing the handwritten note in association with a pose of the on-site client device.

12. The non-transitory computer-readable storage medium of claim 11, wherein capturing annotation from the user of the on-site client device comprises:
capturing, via a microphone, an audio byte of the user.

13. The non-transitory computer-readable storage medium of claim 10, wherein presenting the menu of options comprising presenting a second option in the menu of options for capturing data corresponding to the real-world site, and the operations further comprise:
receiving selection of the second option from the menu of options;
responsive to the selection of the second option, capturing data corresponding to the real-world site; and
transmitting the data to an off-site client device for updating of the AR experience.

14. The non-transitory computer-readable storage medium of claim 13, wherein capturing the data comprises generating a three-dimensional spatial representation of the real-world site from the image data captured by the camera assembly.

15. The non-transitory computer-readable storage medium of claim 13, wherein transmitting the data to the off-site client device comprises transmitting a live feed of the AR experience rendered on the on-site client device.

16. The non-transitory computer-readable storage medium of claim 10, the operations further comprising:
determining a pose of the on-site client device by applying a relocalizer model to the image data to output the pose, wherein the AR experience is rendered based on the pose of the on-site client device.

17. The non-transitory computer-readable storage medium of claim 10, wherein presenting the menu of options comprising presenting a third option in the menu of options for establishing a communication link between the on-site client device and the off-site client device, and the operations further comprise:
receiving selection of the third option from the menu of options; and
responsive to the selection of the third option, establishing the communication link.

18. The non-transitory computer-readable storage medium of claim 17, wherein the communication link is an audio call, a video call, or a combination thereof.

19. A computer-implemented method comprising:
generating, by an off-site client device, an augmented reality (AR) experience for presentation in conjunction with a real-world site;
transmitting the AR experience to an on-site client device;
receiving image data from the on-site client device with other data captured by the on-site client device providing feedback to the AR experience;
presenting the image data captured by the on-site client device on a display of the off-site client device; and
modifying the AR experience based on the other data captured by the on-site client device.

20. The computer-implemented method of claim 19, wherein receiving the other data captured by the on-site client device comprises receiving an annotation captured by the on-site client device, wherein the annotation is a handwritten note provided by the user on a touchscreen display of the on-site client device or an audio byte of the user captured by a microphone of the on-site client device.
